(19) United States
(12) Patent Application Publication
(10) Pub. No.: US 2016/0023634 A1
(43) Pub. Date: Jan. 28, 2016

(54) ANTI-THEFT DEVICE FOR A STEERING COLUMN OF A MOTOR VEHICLE

(71) Applicant: U-SHIN DEUTSCHLAND ZUGANGSSYSTEME GMBH, Erdweg (DE)

(72) Inventors: Anthony Laval, Dachau (DE); Norbert Lehmeier, Ingolstadt (DE)

(73) Assignee: U-Shin Deutschland Zugangssysteme GmbH, Erdweg (DE)

(21) Appl. No.: 14/773,765

(22) PCT Filed: Mar. 12, 2014
(86) PCT No.: PCT/EP2014/054880

§ 371 Date: Sep. 9, 2015

(30) Foreign Application Priority Data
Mar. 13, 2013 (EP) 13159078.8

(51) Int. Cl. B60R 25/021; B60R 25/0215

(52) U.S. Cl. CPC B60R 25/0211; B60R 25/02153

(57) ABSTRACT

An anti-theft device for locking a steering column of a motor vehicle includes a locking bolt that is axially mobile between an unlocked position away from a steering column and a locked position in which it blocks the rotation of said column, a rotary cam for actuating the axial movement of the locking bolt, the rotary cam including a toothed wheel intended to be driven in rotation, where the rotary cam includes an elastic return means of which a first end is secured to the toothed wheel and a second free end projects radially from the toothed wheel and engages with a locking counter-form provided in the locking bolt to block the axial movement of the locking bolt against the elastic return of same to the locked position.

This invention relates to an anti-theft device intended to secure a motor vehicle steering column mechanism.

Anti-theft devices comprise a locking bolt that is mounted mobile in an anti-theft body between an unlocked position wherein the locking bolt is at a distance from a steering column and a locked position wherein it blocks said column.

The locking bolt is controlled in movement by the intermediary of a rotary cam that has a helical ramp engaging with the locking bolt, in order to control the axial movements of the locking bolt between a front anti-theft device position towards which it is elastically urged and wherein it projects towards the front through an opening of the case in order to block in rotation a member of the steering column, and a rear position retracted inside the case.

The rotary cam further has a cam contour able to engage with a control pin carried by the locking bolt. The control pin is urged against the cam contour. The contour has for example a radial shoulder in order to block the axial movement of the control pin and as such block the movement of the locking bolt towards the rear retracted position against the elastic return of same. As such, the radial shoulder prevents an ill-intentioned person from releasing the rotation of the steering column by pushing back the bolt against the elastic return of same.

One of the purposes of this invention is to propose an anti-theft device that is simpler to manufacture.

To this effect, this invention has for object an anti-theft device for locking a steering column of a motor vehicle comprising:

a locking bolt axially mobile between an unlocked position at a distance from a steering column and a locked position wherein it blocks the rotation of said column,

a rotary cam for actuating the axial movement of the locking bolt, said rotary cam comprising a toothed wheel intended to be driven in rotation,

characterised in that the rotary cam comprises an elastic return means of which a first end is secured to the toothed wheel and a second free end projects radially from the toothed wheel and engages with a locking counter-form provided in the locking bolt in order to block the axial movement of the locking bolt against the elastic return of same in the locked position.

As such, the second end of the elastic return means blocks the axial movement of the locking bolt towards the rear retracted position, preventing an ill-intentioned person from releasing the rotation of the steering column by pushing back the locking bolt against the elastic return of same.

The use of an elastic return means of the toothed wheel facilitates the production of the anti-theft device as it makes it possible to avoid the machining of a cam contour and the production of the locking pin associated with anti-theft devices of prior art, that can require complex manufacturing and assembly operations.

In addition, when the locking bolt is arranged between two successive cavities, the additional force required to rotate the rotary cam at the end of travel, must only overcome the return force of the elastic return means. The return force to be overcome is not as substantial as that required in devices of prior art to overcome the friction force of the pre-stressed locking pin against the cam contour, given that in devices of prior art, the constraint of the locking pin must even so be sufficient to prevent the locking bolt from being able to be pushed back into the case.

In addition, the rotation of the toothed wheel to the locked position is used to pre-stress the elastic return means and as such increase its retaining force.

Finally, the energy stored by the elastic return means is not lost since it is restored when the anti-theft device is unlocked.

According to an embodiment, the second end of the elastic return means engages with the locking counter-form in order to block the axial movement axial of the locking bolt during the rotation of the toothed wheel in such a way that the elastic return means is compressed at the end of travel of the toothed wheel.

The locking counter-form has for example a detaching shape so that the engagement between the second end of the elastic return means and the locking counter-form forms on the one hand, a rotation stop for the second end of the torsion spring and on the other hand, an axial stop that blocks the axial movement of the locking bolt.

According to a first embodiment, the elastic return means of the rotary cam comprises a torsion spring.

The torsion spring is for example wound in a cylindrical housing of the toothed wheel, said cylindrical housing having a lateral opening through which the second end projects, with the lateral opening authorising the relative movement of the second end with respect to the toothed wheel.

According to a second embodiment, the elastic return means of the rotary cam comprises a compression spring.

The compression spring is for example arranged around an internal guide, in particular of a shape substantially of an arc of circle, arranged in the toothed wheel.

Other objects, characteristics and advantages of the invention shall appear in the following description, provided by way of example, in an non-restricted manner, with regards to the annexed drawings wherein:

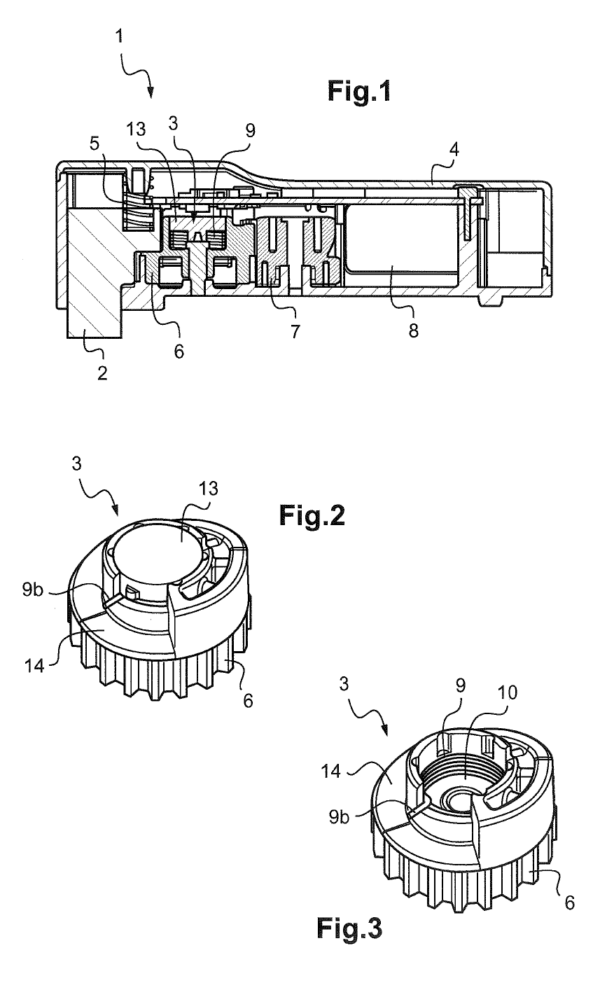

FIG. 1 shows a cross-section view of an anti-theft device for locking a steering column of a motor vehicle, in locked position, according to a first embodiment,

FIG. 2 shows an embodiment of a rotary cam of the anti-theft device of FIG. 1,

FIG. 3 shows a view similar to FIG. 2 wherein the cover of the rotary cam has been removed,

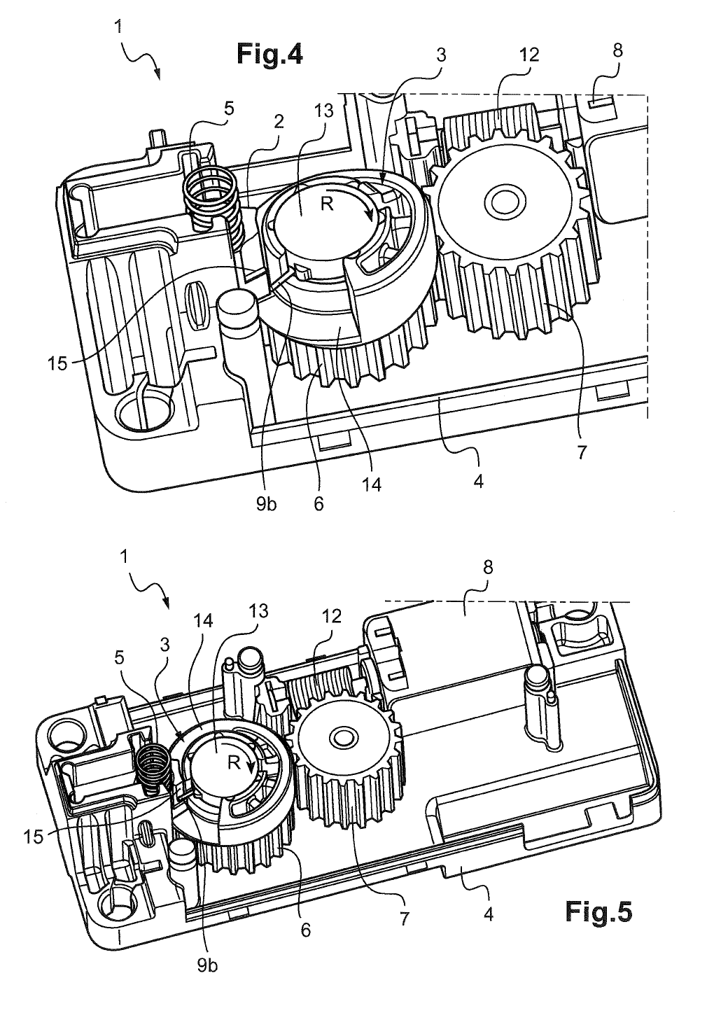

FIG. 4 shows a perspective top view of the anti-theft device of FIG. 1 from which the upper half-case has been removed, with the anti-theft device in “ready to lock” position,

FIG. 5 shows a view similar to FIG. 4, with the rotary cam being driven in rotation in locked position,

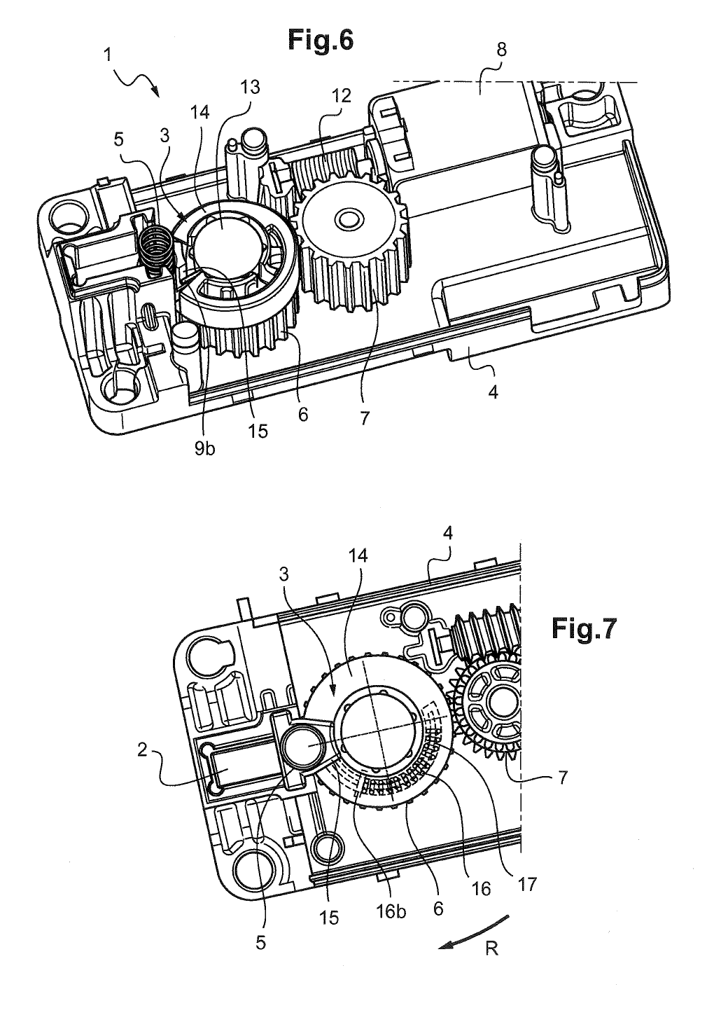

FIG. 6 shows a view similar to FIG. 4 with the rotary cam at the end of travel, and

FIG. 7 shows a second embodiment of the anti-theft device.

In these figures, identical elements bear the same reference numbers.

FIG. 1 shows an anti-theft device 1 for locking a steering column of a motor vehicle.

The anti-theft device 1 comprises a locking bolt 2 and a rotary cam 3 for actuating the locking bolt 2, housed in a case 4 of the anti-theft device 1.

The locking bolt 2, made from one or several assembled parts, is mounted sliding axially in the case 4 between a locked position (FIGS. 5 and 6) wherein it projects axially through an opening of the case 4 and an unlocked position wherein it takes a rear position retracted inside the case 4.

The bolt 2 is elastically urged by a return spring 5 in locked position, in order to block the steering column by being inserted into one of the radial cavities of a member in the form of a ring arranged around the steering column.

In an intermediate position, referred to as “ready for locking” (FIG. 4), the locking bolt 2 is for example pressing against a tooth of the member of the steering column, formed between two successive cavities. An additional rotation of the column is then required in order to force the engagement of the locking bolt 2 into one of the cavities.

As can be seen better in the FIGS. 2 and 3, the rotary cam 3 comprises a toothed wheel 6 having a helical ramp 14, for actuating the axial movement of the locking bolt 2, in particular for raising the locking bolt 2 in the case 4 in unlocked position.

In the example shown in the figures, the toothed wheel 6 is driven in rotation by a gearwheel 7, itself actuated by an electric motor 8 of the anti-theft device 1, via an endless screw 12 (FIG. 4). Although not shown, the invention also applies to anti-theft devices wherein the gearwheel 7 is driven mechanically, as for example by the manual actuating generated by the rotation of a key.

The rotary cam 3 further comprises an elastic return means of which a first end (not visible) is secured to the toothed wheel 6 and a second free end 9b projects radially from the toothed wheel 6 and engages with a locking counter-form 15 provided in the locking bolt 2, in order to block the axial movement of the locking bolt 2 against the elastic return of same 5, in the locked position.

In the first embodiment shown in the FIGS. 1 to 6, the elastic return means of the rotary cam 3 comprises a torsion spring 9. The helical torsion spring 9 is received in a cylindrical housing 10 central of the toothed wheel 6, of which the axis is parallel to the axis of rotation of the toothed wheel 6 (FIG. 3). The wound spires of the torsion spring 9 are pressing against the inner walls of the cylindrical housing 10. The first end is for example secured in a groove of the housing 10, for example by welding.

The cylindrical housing 10 further has a lateral opening through which the second end 9b of the torsion spring 9 projects, with the lateral opening authorising the relative movement of the second end 9b with respect to the toothed wheel 6.

The rotary cam 3 can furthermore comprise a cover 13, having means of locking engaging with additional means of locking carried by the toothed wheel 6, in order to block the torsion spring 9 in the cylindrical housing 10.

The locking counter-form 15 has a detaching shape shaped so that the engagement between the second end 9b and the locking counter-form 15 forms on the one hand, a rotation stop for the second end 9b of the torsion spring 9 and on the other hand, an axial stop that blocks the axial movement of the locking bolt 2 against the elastic return of same 5, in the locked position (FIGS. 5 and 6).

It is also provided that the second end 9b engages with the locking counter-form 15, during the rotation of the toothed wheel 6, in such a way that the torsion spring 9 is compressed at the end of travel of the toothed wheel 6, in the locked position (FIG. 6).

As such, during operation, in the ready for locking position (FIG. 4), the locking bolt 2 is at a distance from the steering column. The second free end 9b of the torsion spring 9 is in contact against the locking bolt 2.

Then, the rotation of the toothed wheel 6 (in the clockwise direction represented by the arrow R in FIG. 4), allows the locking bolt 2 to slide to the “front” position of the opening of the case 4.

During the rotation of the toothed wheel 6 (arrow R in FIG. 5) and of the descent of the locking bolt 2, the second end 9b of the torsion spring 9 that extends beyond the toothed wheel 6, engages with the locking counter-form 15 of the locking bolt 2, preventing the raising of the locking bolt 2 in its rear retracted position.

The rotation of the toothed wheel 6 to the locked position is used to pre-stress the torsion spring 9 and as such increase the retaining force of the locking bolt 2.

In locked position, at the end of the course of the toothed wheel 6 (FIG. 6), the locking bolt 2 is arranged in a cavity of the member of the steering column.

In this locked position, the torsion spring 9 is pre-stressed and the second end 9b of the torsion spring 9 blocks the axial movement of the locking bolt 2 to the rear retracted position. As such, the second end 9b of the torsion spring 9 prevents an ill-intentioned person from releasing the rotation of the steering column by pushing back the locking bolt 2 against the elastic return of same 5.

The utilisation of the torsion spring 9 facilitates the production of the anti-theft device as it makes it possible to avoid the machining of a cam contour and the production of the locking pin associated with anti-theft devices of prior art, that can require complex manufacturing and assembling operations.

In addition, when the locking bolt 2 is arranged between two successive cavities, the additional force required to rotate the rotary cam 3 at the end of travel, must only overcome the return force in torsion of the torsion spring 9. The return force in torsion of the torsion spring 9 is not as substantial as the force required in devices of prior art to overcome the friction of the pre-stressed locking pin against the cam contour, given that in devices of prior art, the constraint of the locking pin must even so be sufficient to prevent the locking bolt from being able to be pushed back into the case.

Finally, the energy stored by the torsion spring 9 is not lost since it is restored when the 1 is unlocked.

According to a second embodiment shown in FIG. 7, the elastic return means of the rotary cam 3 comprises a compression spring 16.

A first end of the compression spring 16 is secured to the toothed wheel 6 and a second end 16b projects radially from the toothed wheel 6.

According to this embodiment, the compression spring 16 is arranged around an internal guide 17 made in the toothed wheel. The internal guide 17 can be cylindrical. Said guide 17 can have a shape substantially as an arc of circle. The compression spring 16 can be compressed and be expanded along the form of the internal guide 17.

The engagement between the second end 16b and the locking counter-form 15 forms on the one hand, a rotation stop for the second end 16b of the compression spring 16 and on the other hand, an axial stop that blocks the axial movement of the locking bolt 2 against the elastic return of same 5, in the locked position.

Also, the second end 16b engages with the locking counter-form 15, during the rotation of the toothed wheel 6, in such a way that the compression spring 16 is compressed at the end of travel of the toothed wheel 6, in the locked position.

As such, during operation, and as for the first embodiment, the rotation of the toothed wheel 6 in the clockwise direction in the example (represented by the arrow R in FIG. 7), drives the exiting of the locking bolt 2. The second end 16b of the compression spring 16 engages with the locking counter-form 15 of the locking bolt 2, preventing the raising of the locking bolt 2 in its rear retracted position. The rotation of the toothed wheel 6 to the locked position pre-stresses the compression spring 16, which increases the retaining force of the locking bolt 2.

1. Anti-theft device for locking a steering column of a motor vehicle comprising:
a locking bolt axially mobile between an unlocked position at a distance from a steering column and a locked position wherein it blocks the rotation of said column; and
a rotary cam for actuating the axial movement of the locking bolt, said rotary cam comprising a toothed wheel intended to be driven in rotation,
wherein the rotary cam comprises an elastic return means of which a first end is secured to the toothed wheel and a second free end projects radially from the toothed wheel and engages with a locking counter-form provided in the locking bolt in order to block the axial movement of the locking bolt against the elastic return of same in the locked position.

2. The anti-theft device according to claim 1 wherein the second end of the elastic return means engages with the locking counter-form in order to block the axial movement of the locking bolt during the rotation of the toothed wheel in such a way that the elastic return means is compressed at the end of travel of the toothed wheel.

3. The anti-theft device according to claim 1, wherein the locking counter-form has a detaching shape so that the engagement between the second end of the elastic return means and the locking counter-form forms on the one hand, a rotation stop for the second end of the torsion spring and on the other hand, an axial stop that blocks the axial movement of the locking bolt.

4. The anti-theft device according to claim 1, wherein the elastic return means of the rotary cam comprises a torsion spring.

5. The anti-theft device according to claim 4, wherein the torsion spring is wound in a cylindrical housing of the toothed wheel, said cylindrical housing having a lateral opening through which the second end projects, with the lateral opening authorising the relative movement of the second end in relation to the toothed wheel.

6. The anti-theft device according to claim 1, wherein the elastic return means of the rotary cam comprises a compression spring.

7. The anti-theft device as claimed in claim 6, wherein the compression spring is arranged around an internal guide made in the toothed wheel.
